(19) United States
(12) Patent Application Publication
(10) Pub. No.: US 2020/0051451 A1
(43) Pub. Date: Feb. 13, 2020

(54) SHORT ANSWER GRADE PREDICTION

(71) Applicant: Actively Learn, Inc., Seattle, WA (US)

(72) Inventors: Jay Goyal, Seattle, WA (US); Sergey Feldman, Seattle, WA (US); Ilya Barshai, Skokie, IL (US)

(73) Assignee: Actively Learn, Inc., Seattle, WA (US)

(21) Appl. No.: 16/537,493

(22) Filed: Aug. 9, 2019

Related U.S. Application Data
(60) Provisional application No. 62/717,723, filed on Aug. 10, 2018.

(51) Int. Cl. G09B 7/02; G06N 3/04; G06K 9/62; G06F 17/27

(52) U.S. Cl. CPC G09B 7/02; G06F 17/27; G06K 9/6215; G06N 3/0481

(57) ABSTRACT

Implementations include computer-implemented methods, computer-readable medium, and/or systems for short answer grade prediction.

### RELATED APPLICATIONS

This application claims the benefit of U.S. Provisional Application No. 62/717,723, entitled “Short Answer Grade Prediction,” and filed on Aug. 10, 2018, which is incorporated herein by reference in its entirety.

### BACKGROUND

Some types of test grading have been automated such as multiple choice, numerical answers, etc. For other types of test questions, such as short answers, e.g., in free-form text, grading can be time consuming. A need may exist to provide an automatic grade generation or prediction for short answer format test questions.

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

Some implementations are generally related to computerized testing, and in particular to systems, methods, and computer readable media for short answer grade prediction.

Some implementations can include a computer-implemented method. The method can include receiving a short answer response to a test prompt and determining a number of previously graded responses to the test prompt. The method can also include, when the number of previously graded responses to the test prompt meets a threshold, providing the short answer response, one or more previously graded responses, and the test prompt to a similarity model, and determining, using the similarity model, a similarity between the short answer response and the one or more previously graded responses.

The method can further include providing the similarity between the short answer response and the one or more previously graded responses and a previously determined grade for the one or more previously graded responses to a grading model, and generating, using the grading model, a grade prediction for the short answer response. In some implementations, determining the similarity between the short answer response and the one or more of the identified correct short answers includes programmatically determining the similarity based on one or more of characters, words, word usage, word order, or word placement within the short answer response.

In some implementations, determining the similarity between the short answer response and the one or more of the previously graded responses includes determining a value having a range representing a degree of similarity between the short answer response and the one or more previously graded responses. The method can also include displaying a user interface that presents the grade prediction.

The method can further include storing the grade prediction in a database. The method can also include combining the grade prediction with grades for other responses provided by the student during a particular test to generate an overall score for the student for the particular test.

The method can further include providing a suggestion of the grade prediction to a teacher, and providing a user interface for the teacher to accept or modify the grade prediction.

The method can further include training the similarity model, wherein the training of the similarity model includes generating one or more question and answer tuples as training samples, wherein the question and answer tuples each include two or more answers, providing the one or more question and answer tuples to the similarity model, generating a similarity score representing similarity between the two or more answers, predicting a grade based on the similarity score using the grading model, and adjusting one or more parameters of the similarity model based on the grade predicted by the grading model.

In some implementations, training the similarity model further comprises comparing the grade predicted by the similarity model with a known grade for a corresponding training sample, wherein the similarity model includes a neural network and wherein adjusting one or more parameters of the similarity model includes adjusting one or more weights in one or more layers of the neural network using as feedback a difference between the grade predicted by the grading model and the known grade for the corresponding training sample. In some implementations, training the similarity model or grading model is completed when one or more grades predicted by the grading model are within a threshold of one or more corresponding known grades.

The method can also include providing as input to the similarity model a first similarity function result based on the short answer response and one of the previously graded responses, a second similarity function result based on the short answer response, one of the previously graded responses and the test prompt, and an overlap function results based on the short answer response and one of the previously graded responses. The method can further include providing as input to the grading model a distribution of the similarity between the short answer response, the one or more previously graded responses, and grades for the one or more previously graded responses.

Some implementations can include a non-transitory computer readable medium having stored thereon instructions that, when executed by a processor, cause the processor to perform operations. The operations can include receiving a short answer response to a test prompt and determining a number of previously graded responses to the test prompt. The method can also include, when the number of previously graded responses to the test prompt meets a threshold, providing the short answer response, one or more previously graded responses, and the test prompt to a similarity model, and determining, using the similarity model, a similarity between the short answer response and the one or more previously graded responses. The method can further include providing the similarity between the short answer response and the one or more previously graded responses and a previously determined grade for the one or more previously graded responses to a grading model, and generating, using the grading model, a grade prediction for the short answer response.

In some implementations, determining the similarity between the short answer response and one or more previously graded responses includes programmatically determining a similarity based on characters, words, word usage, word order, or word placement within the short answer response. In some implementations, determining the similarity between the short answer response and one or more previously graded responses includes determining a value having a range representing a degree of similarity between the short answer response and the one or more previously graded responses.

Some implementations can include a system comprising one or more processors, and a memory coupled to the one or more processors and having instructions stored thereon that, when executed, cause the one or more processors to perform operations. The operations can include receiving a short answer response to a test prompt and determining a number of previously graded responses to the test prompt. The operations can also include, when the number of previously graded responses to the test prompt meets a threshold, providing the short answer response, one or more previously graded responses, and the test prompt to a similarity model, and determining, using the similarity model, a similarity between the short answer response and the one or more previously graded responses. The operations can further include providing the similarity between the short answer response and the one or more previously graded responses and a previously determined grade for the one or more previously graded responses to a grading model, and generating, using the grading model, a grade prediction for the short answer response.

The operations can further include combining the grade prediction with grades for other responses provided by a student during a particular test to generate an overall score for the student for the particular test. The operations can also include providing a suggestion of the grade prediction to a teacher, and providing a user interface for the teacher to accept or modify the grade prediction.

The operations can also include providing as input to the similarity model a first similarity function result based on the short answer response and one of the previously graded responses, a second similarity function result based on the short answer response, one of the previously graded responses and the test prompt, and an overlap function results based on the short answer response and one of the previously graded responses. The operations can further include providing as input to the grading model a distribution of the similarity between the short answer response, the one or more previously graded responses, and grades for the one or more previously graded responses.

### BRIEF DESCRIPTION OF THE DRAWINGS

FIG. 1 is a block diagram of an example short answer test grading system and a network environment, in accordance with some implementations.

FIG. 2 is a diagram of a short answer grade prediction system with example inputs and outputs, in accordance with some implementations.

FIG. 3 is a flowchart of an example method for short answer grade prediction, in accordance with some implementations.

FIG. 4 is a flowchart of an example method for training a model for short answer grade prediction, in accordance with some implementations.

FIG. 5 is a block diagram of an example device which may be used for one or more implementations described herein.

FIG. 6 is a diagram of an example user interface for short answer grade prediction, in accordance with some implementations.

FIG. 7 is a diagram of a short answer grade prediction system with example inputs and outputs, in accordance with some implementations.

FIG. 8 is a flowchart of an example method for short answer grade prediction, in accordance with some implementations.

### DETAILED DESCRIPTION

The systems and methods provided herein may overcome one or more deficiencies of some conventional computerized testing systems and methods. For example, short answer grade prediction based on a machine learning model can help reduce variation in manual grading and also can help reduce time required to obtain a grade for a short answer response provided via a computer system. Short answer responses can include, but aren't limited to, responses of less than 20 words, responses between 5-10 words, free form text responses less than 2 paragraphs, spoken word responses less than 20 seconds, etc.

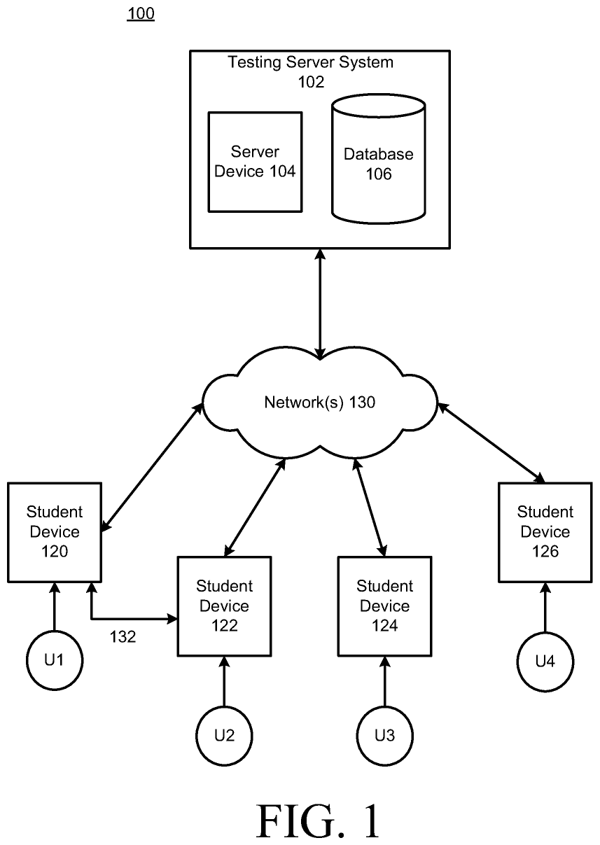

FIG. 1 illustrates a block diagram of an example environment 100, which may be used in some short answer grading implementations described herein. In some implementations, environment 100 includes one or more testing server systems, e.g., testing server system 102 in the example of FIG. 1. Testing server system 102 can communicate with a network 130, for example. Testing server system 102 can include a server device 104 and a database 106 or other storage device. The testing server system 102 can include a cloud computing and/or storage system. Environment 100 also can include one or more student devices, e.g., student devices 120, 122, 124, and 126, which may communicate with each other and/or with testing server system 102 via a network 130. The network 130 can be any type of communication network, including one or more of the Internet, local area networks (LAN), wireless networks, switch or hub connections, etc. In some implementations, network 130 can include peer-to-peer communication 132 between devices, e.g., using peer-to-peer wireless protocols.

For ease of illustration, FIG. 1 shows one block for testing server system 102, server device 104, and database 106, and shows four blocks for student devices 120, 122, 124, and 126. Blocks representing server system 102, 104, and 106 may represent multiple systems, server devices, and network databases, and the blocks can be provided in different configurations than shown. For example, testing server system 102 can represent multiple server systems that can communicate with other server systems via the network 130. In some examples, database 106 and/or other storage devices can be provided in server system block(s) that are separate from server device 104 and can communicate with server device 104 and other server systems via network 130. Also, there may be any number of student devices.

Each student device can be any type of electronic device, e.g., desktop computer, laptop computer, portable or mobile device, wearable device, etc. Some student devices may also have a local database similar to database 106 or other storage. In other implementations, environment 100 may not have all of the components shown and/or may have other elements including other types of elements instead of, or in addition to, those described herein.

In various implementations, student users U1, U2, U3, and U4 may comprise one or more students in an education environment and may communicate with the testing server system 102 and/or each other using respective student devices 120, 122, 124, and 126. In some examples, users U1, U2, U3, and U4 may interact with each other via applications running on respective client devices and/or server system 102, and/or via a network service, e.g., a chat/messaging messaging service, a social network service, or other type of network service, implemented on server system 102. For example, respective client devices 120, 122, 124, and 126 may communicate data to and from one or more server systems (e.g., server system 102).

In some implementations, the testing server system 102 may provide data to the student devices such that each student device can receive communicated educational content or shared educational content uploaded to the server system 102 and/or network service. In some examples, the students can interact with an instructor or each other via audio or video conferencing, audio, video, or text chat, or other communication modes or applications. In some examples, the network service can include any system that enables users to perform a variety of communications, receive various forms of data, and/or perform educational functions. For example, the network service can allow a student to take a test, e.g., receive one or more questions and provide a short answer response, e.g., text, voice, etc.

A user interface can display lesson materials such as test questions, reading material for the lesson, and other materials materials such as images, image compositions, video, data, and other content as well as communications, privacy settings, notifications, and other data on a student device 120, 122, 124, and 126 (or alternatively on the testing server system 102). Such an interface can be displayed using software on the student device, software on the server device, and/or a combination of client software and server software executing on server device 104, e.g., application software or client software in communication with testing server system 102. The user interface can be displayed by a display device of a student device or server device, e.g., a display screen, projector, etc. In some implementations, application programs running on a server system can communicate with a student device to receive user input at the client device and to output data such as visual data, audio data, etc. at the client device.

Various implementations of features described herein can use any type of educational system and/or service. For example, educational systems, social networking services, image collection and sharing services, assisted messaging services or other networked services (e.g., connected to the Internet) can include one or more described features accessed by student and server devices. Any type of electronic device can make use of features described herein. Some implementations can provide one or more features described herein on client (e.g., student) or server devices disconnected from or intermittently connected to computer networks. In some examples, a student device including or connected to a display device can examine and display images stored on storage devices local to the student device (e.g., not connected via a communication network) and can provide features and results as described herein that are viewable to a user.

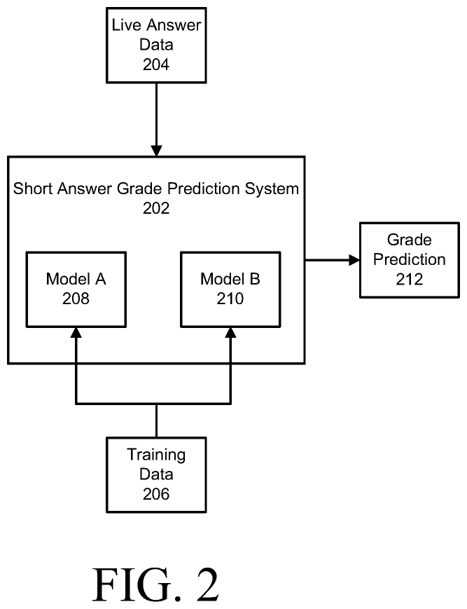

FIG. 2 is a diagram of a short answer grade prediction system with example inputs and outputs in accordance with some implementations. In particular, a short answer grade prediction system 202 can include one or more models such as model A 208 and model B 210. The models can include a neural network as described below. The models (208 and 210) can be trained based on received training data 206. The training data 206 can include one or more of assignment data (e.g., reading material and/or questions pertaining to that reading material); reading material (e.g., material intended to be read prior to answering questions and providing context to the responses, such as a short article or a specific section of a larger text); question (e.g., short answer prompt assigned by a teacher, and can be embedded in the reading material or immediately following it); responses (e.g., typed out, textual response from a student to a question, using the reading material as evidence or context); or true (or known) grade data (e.g., teacher scoring of the response based on a grading scale, for example of 0 to 4).

To predict grades for short answers received, e.g., from a student device, two distinct models (e.g., neural networks) can be used. The choice of which model to use (e.g., model A 208 or model B 210) can depend on whether historical responses for a question are available or not and meet a threshold number. Based on the availability of historical responses, the short answer grading system determines the model to use for a given prompt and short answer.

Model A (208) can include a model with historical responses. For example, if a response to be graded is a response to a question for which past responses and grades, e.g., from other classes or previous classes taught by the same teacher, or other teachers, are available, the model architecture can be a Siamese neural network, for example. In the model there can be two parallel branches, one for the response to be graded, one for a different response, with the same layers that share learned parameters. The layers in each branch can include:

1. An embedding layer—to learn embeddings (e.g., learn the embeddings during training and stores them for later use during prediction), or multi-dimensional numerical representations, for multiple features of a response's text, such as the lower-case version, shape, prefixes, and suffixes of the words. Using parts of the word such as its shape, suffix, and prefix allows system 202 to learn more general notions about words and allows the model to generalize better during grade generation about words that might have never been provided during the training phase. The embeddings of the different word features can then be combined to create one embedding per word.

2. A pooling layer—this layer combines embeddings for different words into one concept of a response. Within the pooling layer, an attention mechanism learns the weight to assign to each word of a response during the pooling. This provides finer control of which words within a response carry greater weight when computing the similarity between two responses with respect to how closely they have been graded.

3. A similarity computation layer—this layer computes the cosine similarity between the embedding vectors of the responses from the two branches, combining them into one similarity score.

4. A grade prediction layer—this layer scales the similarity to a grading scale (e.g., to a scale of 0-4).

If the response to be graded is for a question for which no more than a threshold number (e.g., 1, 3, 5, 10, etc.) past grades have been determined, the system can utilize model B 210, which can include a two-part architecture. The first part learns embeddings of the sentences in the reading material and the question, and uses those learned embeddings to identify the most likely sentence(s) in the reading material that contain the answer to the question. Because it is likely that, for reasoning tasks, the answer is not contained within a single sentence, the model can select a plurality of sentences from the reading material based on a learned similarity threshold.

Model B 210 can include layers similar to those mentioned above for model A and can use learned embeddings of the selected sentences as the input to the pooling layer to get a single, question-aware representation of the reading material. A different branch of this architecture can learn embeddings of the response to be graded, after which the system can determine how similar the response is to the question-aware reading material embedding and assign a grade based on that similarity score.

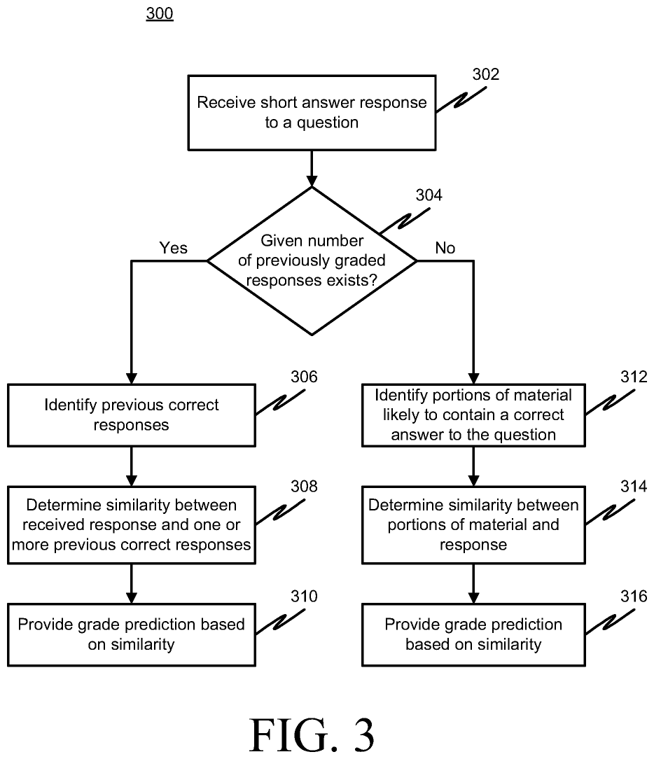

FIG. 3 is a flow diagram illustrating an example method 300 (e.g., a computer-implemented method) to predict grades for short answer responses, according to some implementations.

In some implementations, method 300 can be implemented, for example, on a server system 102 as shown in FIG. 1. In other implementations, some or all of the method 300 can be implemented on one or more student devices 120, 122, 124, or 126 as shown in FIG. 1, one or more server devices, and/or on both server device(s) and client device(s). In described examples, the implementing system includes one or more digital hardware processors or processing circuitry (“processors”), and one or more storage devices (e.g., a database 106 or other storage). In some implementations, different components of one or more servers and/or clients can perform different blocks or other parts of the method 300.

In some implementations, the method 300, or portions of the method, can be initiated automatically by a device. For example, the method (or portions thereof) can be periodically performed or performed based on the occurrence of one or more particular events or conditions. For example, such events or conditions can include a short answer response being received by, uploaded to, or otherwise being accessible by a device (e.g. a student device), a predetermined time period having expired since the last performance of method 300, and/or one or more other events or conditions occurring which can be specified in settings of a device implementing method 300. In some implementations, such conditions can be previously specified by a user in stored custom preferences of the user (accessible by a device or method with user consent). In some examples, a device (server or client) can perform the method 300 with access to one or more applications that receive short answer responses. In another example, a student device can receive electronic short answer responses and can perform the method 300. In addition, or alternatively, a client device can send one or more short answer responses to a server over a network, and the server can process the messages using method 300.

Processing begins at 302, where a short answer response is received. In addition to the response, a question and reading material associated with the response can also be received. Processing continues to 304.

At 304, it is determined whether a threshold number of previously graded responses have been received for the question corresponding to the short answer response. For example, there may be a threshold number that is used to determine which model to use in predicting a grade for the short answer. If a threshold number of previously graded responses to the question exists, processing continues to 306, otherwise processing continues to 312.

At 306, previously graded responses to the question are identified. For example, these may be obtained from a database that stores correct answers to questions being graded and the correct answer corresponding to a particular question can be identified within the database (e.g., by question text, question number, etc.). Processing continues to 308.

At 308, a similarity between the short answer response and one or more of the identified correct short answers is determined. The similarity can represent the degree to which a short answer response matches historical responses (or the question or reading material). The similarity can be programmatically determined based on word usage, word order, or word placement, etc. within the short answer response. Similarity can include a value having a range representing how similar the short answer response is to one or more identified correct short answers. Processing continues to 310.

At 310, a grade prediction is generated based on the similarity determined at 308. For example, a grade prediction can be provided based on the similarity (e.g., a similarity of 90-100% can receive a grade prediction of A; a similarity of 80-89% can receive a grade prediction of B, and so on). The similarity and grade prediction of steps 308 and 310 can be performed by a model trained using actual answers (e.g., model A 208). Processing for the grade prediction ends at 310.

At 312, one or more portions of lesson material (e.g., questions, reading material, etc.) likely to contain a correct answer are identified. Processing continues to 314.

At 314, a similarity between the short answer response and one or more of the identified portions is determined. The similarity can be programmatically determined based on word usage, word order, word placement, etc. between the short answer response and the one or more portions. Similarity can include a value having a range representing how similar the short answer response is to one or more identified correct short answers. Processing continues to 316.

At 316, a grade prediction is generated based on the similarity determined at 314. For example, grade prediction can be provided based on the similarity (e.g., a similarity of 90-100% can receive a grade prediction of A; a similarity of 80-89% can receive a grade prediction of B, and so on). The similarity and grade prediction of steps 314 and 316 can be performed by a model (e.g., model B 210) trained using lesson materials such as reading material, questions etc. Processing for the grade prediction ends at 316. It will be appreciated that one or more of 302-316 can be repeated in whole or in part.

Upon determination of the grade, the grade may be presented, e.g., via a user interface on a student device (e.g., any of devices 120-126), to a student that provided the short answer response. The grade can also be stored, e.g., in a database along with an identifier of the student. Further, the grade may be combined with, e.g., grades for other responses provided by the student during a particular test, e.g., to provide an overall score for the student for the particular test. Some implementations can provide a suggestion of the determined grade to the teacher, and allow the teacher to accept or modify the determined grade.

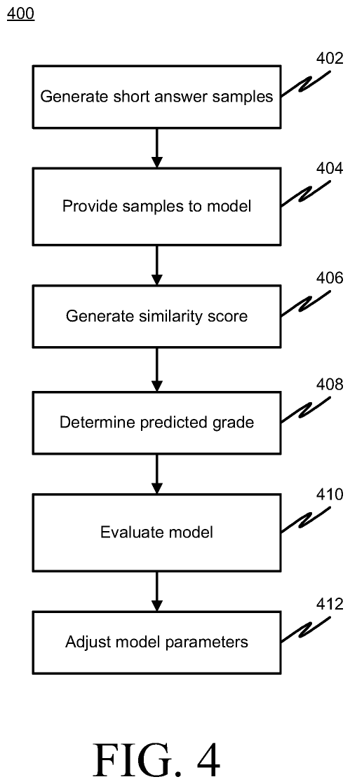

FIG. 4 is a flowchart illustrating an example method 400 (e.g., a computer-implemented method) to train models to predict grades for short answer responses, according to some implementations. The models can be trained offline and the trained models can contain a representation that is then used to generate grade predictions.

In some implementations, method 400 can be implemented, for example, on a server system 102 as shown in FIG. 1. In other implementations, some or all of the method 400 can be implemented on one or more student devices 120, 122, 124, or 126 as shown in FIG. 1, one or more server devices, and/or on both server device(s) and client device(s). In described examples, the implementing system includes one or more digital hardware processors or processing circuitry (“processors”), and one or more storage devices (e.g., a database 106 or other storage). In some implementations, different components of one or more servers and/or clients can perform different blocks or other parts of the method 400.

Processing begins at 402, where short answer samples and assignment information are generated. The samples can include a response for grading (e.g., in online training), one or more historical correct responses, the question, reading material associated with the question, and/or grades for the one or more historical correct responses. Training samples can be obtained from previous responses graded by teachers for students on the platform. For example, when a system recognizes a known question, the system can find and use previous graded responses for that question from other students.

Two models (e.g., neural network models) can be built, one for the scenario in which historical responses for a question are available, and one for the scenario in which historical responses for a question are not available, using the architectures (e.g., as shown in FIGS. 1 and 2) that perform the tasks of FIGS. 3 and 4. The models are trained on historical data in order to adjust parameters of the model to determine whether text is similar and dissimilar in the context of a contemplated short answer grading task the model is being trained for. Processing continues to 404.

At 404, training samples are provided to one or more of the models. For example, the model training samples may be provided as tuples, such as question and answer tuples, where each tuple includes a question and a short answer response. In some implementations, the samples can include either two or more responses for model A or a response, a question and the corresponding reading material for model B. In some implementations, the models can be trained on responses for which grades are available in a supervised learning format. Processing continues to 406.

At 406, similarity scores are generated for the samples. The similarity scores can be programmatically determined based on word usage, word order, word placement, etc. between two or more of the short answer responses (e.g., between a short answer response being graded and one or more historical short answer responses). The similarity scores can include a range representing how similar a short answer response is to one or more identified correct short answers. Processing continues to 408.

At 408, a predicted grade is determined based on the similarity scores. Processing continues to 410. When model A is applicable, the grade prediction can include can include comparing the responses to historical correct responses. Responses that are similar to historical correct responses are expected to have higher grades. When Model B is applicable, responses that are similar to both the reading material and question are also expected to have higher grades.

At 410, the model predictions are evaluated. Based on the training using historical responses, the system can evaluate how well the model is performing (e.g., how close the predicted grade is to the true grade, for example).

For example, the models can be trained on known “question-answer-grade” tuples. Then, question and answer pairs from the training data can be supplied to the model and grades generated by model can be compared with known grades for the question-answer pairs. Weights of neural network nodes in one or more layers of a neural network can be adjusted using as feedback the difference between generated grade and known grades. A model may be considered trained when the grade (or a plurality of grades) produced by the model is within a threshold of a corresponding known grade (or plurality of known grades) in the training data. Processing continues to 412.

At 412, numerical parameters (e.g., weights) of the model are adjusted based on the evaluation at block 410. Processing can continue and include repeating one or more of steps 402-412 with new batches of random samples at each iteration until the predictions produced by the model are no longer improving. During the training process, predictions are generated for historical responses for which true grades assigned by teachers are available. A group of responses can be held out from the training data, the model (or models) is trained for one iteration, and the new state of the model (or models) can be used to predict grades for the held out group of responses. The predicted grades can then be compared to the true grades to determine an aggregated score of model performance (e.g., mean absolute error, root mean squared error, etc). When this aggregated score stops improving (e.g., error stops getting lower, or is getting lower by an amount less than a threshold) after multiple iterations of training, model learning can be considered to have reached a termination condition and training can be stopped.

The model can be trained on a variety questions, responses, and reading material of a lesson to learn a language model. The language model may be applicable to questions, responses, or texts written in the English language (different languages would require different models). The model can be trained on responses to questions for a wide variety of subjects, such as English, history, etc., so that the model may perform better for subjects corresponding to the training data.

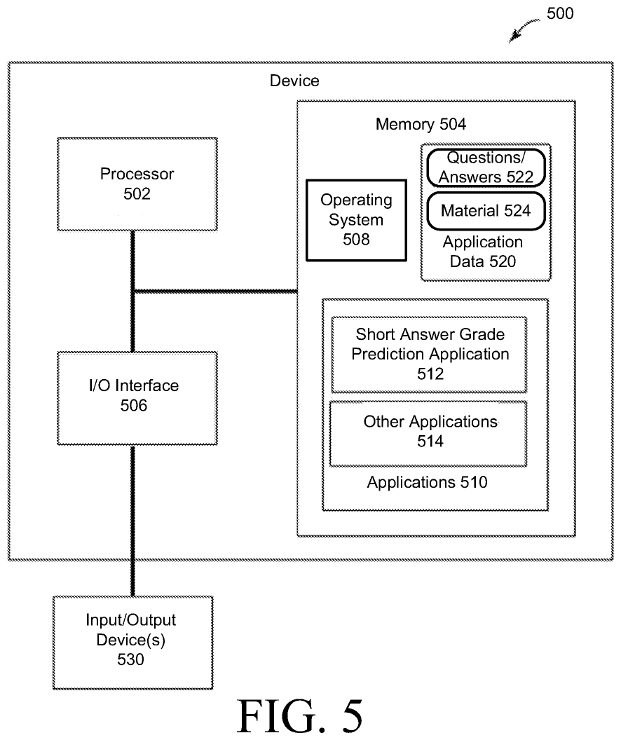

FIG. 5 is a block diagram of an example device 500 which may be used to implement one or more features described herein. In one example, device 500 may be used to implement a computer device, e.g., a server device (e.g., server device 104 of FIG. 1) and/or a student device, and perform appropriate method implementations described herein. Device 500 can be any suitable computer system, server, or other electronic or hardware device. For example, the device 500 can be a mainframe computer, desktop computer, workstation, portable computer, or electronic device (portable device, mobile device, cell phone, smart phone, tablet computer, television, TV set top box, personal digital assistant (PDA), media player, game device, wearable device, etc.). In some implementations, device 500 includes a processor 502, a memory 504, and I/O interface 506.

Processor 502 can be one or more processors and/or processing circuits to execute program code and control basic operations of the device 500. A “processor” includes any suitable hardware and/or software system, mechanism or component that processes data, signals or other information. A processor may include a system with a general-purpose central processing unit (CPU), multiple processing units, dedicated circuitry for achieving functionality, or other systems. Processing need not be limited to a particular geographic location, or have temporal limitations. For example, a processor may perform its functions in “real-time,” “offline,” in a “batch mode,” etc. Portions of processing may be performed at different times and at different locations, by different (or the same) processing systems. A computer may be any processor in communication with a memory.

Memory 504 is typically provided in device 500 for access by the processor 502, and may be any suitable processor-readable storage medium, e.g., random access memory (RAM), read-only memory (ROM), Electrical Erasable Read-only Memory (EEPROM), Flash memory, etc., suitable for storing instructions for execution by the processor, and located separate from processor 502 and/or integrated therewith. Memory 504 can store software operating on the server device 500 by the processor 502, including an operating system 508, one or more applications 510, e.g., an alternative interface presentation application 512, other applications 514 and application data 520. In some implementations, applications 510 can include instructions that enable processor 502 to perform the functions described herein, e.g., some or all of the methods of FIGS. 3, 4, and 8.

For example, applications 510 can include a short answer grade prediction application 512, which as described herein can provide short answer grade predictions. Other applications 514 (or engines) can also or alternatively be included in applications 510, e.g., email applications, SMS and other phone communication applications, web browser applications, media display applications, communication applications, web hosting engine or application, social networking engine or application, etc. Any of software in memory 504 can alternatively be stored on any other suitable storage location or computer-readable medium. In addition, memory 504 (and/or other connected storage device(s)) can store application data such as questions (or prompts), previously short answer responses, lesson materials, grades of previous responses, and other instructions and data used in the features described herein. Memory 504 and any other type of storage (magnetic disk, optical disk, magnetic tape, or other tangible media) can be considered “storage” or “storage devices.”

For example, application data 520 can include questions and answers 522 and lesson materials 524 (e.g., reading materials, etc.).

I/O interface 506 can provide functions to enable interfacing the device 500 with other systems and devices. For example, network communication devices, storage devices (e.g., memory and/or database 106), and input/output devices can communicate via I/O interface 506. In some implementations, the I/O interface can connect to interface devices including input devices (keyboard, pointing device, touchscreen, microphone, camera, scanner, etc.) and/or output devices (display device, speaker devices, printer, motor, haptic output device, etc.). Audio input/output devices 530 are an example of input and output devices that can be used to receive audio input and provide audio output (e.g., voice interface output) as described herein. Audio input/output devices 530 can be connected to device 500 via local connections (e.g., wired bus, wireless interface) and/or via networked connections and can be any suitable devices, some examples of which are described below.

For ease of illustration, FIG. 5 shows one block for each of processor 502, memory 504, I/O interface 506, and software blocks 508 and 510. These blocks may represent one or more processors or processing circuitries, operating systems, memories, I/O interfaces, applications, and/or software modules. In other implementations, device 500 may not have all of the components shown and/or may have other elements including other types of elements instead of, or in addition to, those shown herein. While server system 102 is described as performing operations as described in some implementations herein, any suitable component or combination of components of server system 102 or similar system, or any suitable processor or processors associated with such a system, may perform the operations described.

A client device can also implement and/or be used with features described herein, e.g., client devices 120-126 shown in FIG. 1. Example client devices can be computer devices including some similar components as the device 500, e.g., processor(s) 502, memory 504, and I/O interface 506. An operating system, software and applications suitable for the client device can be provided in memory and used by the processor, e.g., image management software, client group communication application software, etc. The I/O interface for a client device can be connected to network communication devices, as well as to input and output devices, e.g., a microphone for capturing sound, a camera for capturing images or video, audio speaker devices for outputting sound, a display device for outputting images or video, or other output devices. Audio input/output devices 530, for example, can be connected to (or included in) the device 500 to receive audio input (e.g., voice commands) and provide audio output (e.g., voice interface) and can include any suitable devices such as microphones, speakers, headphones, etc. Some implementations can provide an audio output device, e.g., voice output or synthesis that speaks text.

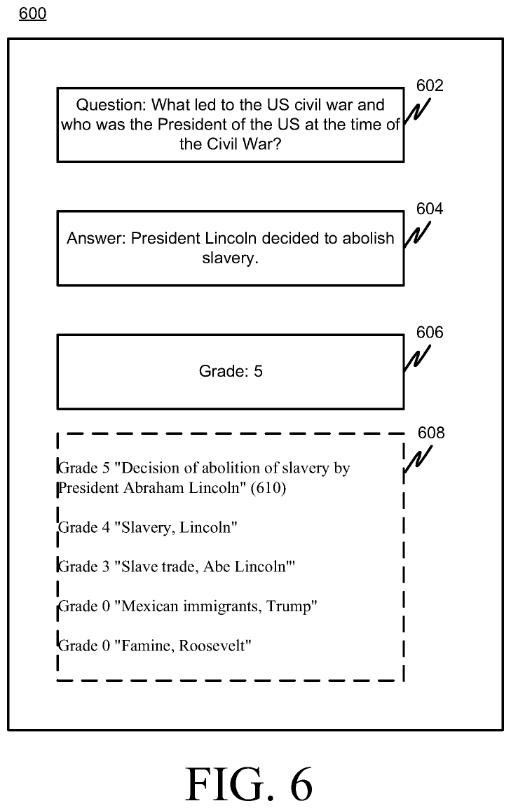

FIG. 6 is a diagram of an example user interface 600 for short answer grading in accordance with some implementations. The interface 600 can include a question section 602, a response section 604, a predicted grade section 606, and one or more grade prediction grade-content references 608. The user interface 600 can be implemented for a student, in which case elements 602, 604, and 606 would be displayed. The interface 600 can also be implemented for an instructor to review predicted grades for evaluation of the system, teacher review, or training of the system. In the instructor implementation, the interface 600 can include elements 602, 604, 606, and 608.

In a student implementation, a question can be displayed to a student in element 602. The student can enter a short answer response in element 604. The system can generate a predicted grade as described herein and the predicted grade can be displayed at element 606.

In the instructor implementation, the user interface 600 can be used for an instructor to review a predicted grade by displayed a question in 602, a student's response in 604, and the predicted grade in 606. Also, the grade prediction grade-content references 608 can be displayed for an instructor to give the instructor an idea about how the grade prediction system is functioning.

In the example shown in FIG. 6, the short answer response of “President Lincoln decided to abolish slavery” is similar to the grade prediction grade-content reference 610. Accordingly, the short answer was predicted to have a grade of 5. Other answers can also get a grade of 5, for example “The Civil War started in response to President Lincoln seeking to abolish slavery.”

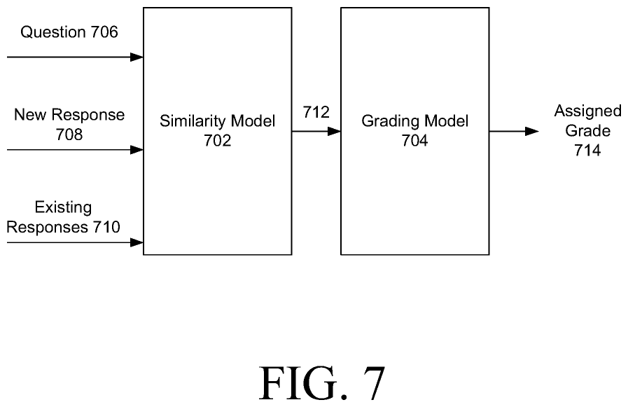

FIG. 7 is a diagram of a short answer grade prediction system with example inputs and outputs, in accordance with some implementations. The system includes a similarity model 702 and a grading model 704.

In operation, inputs are provided to the similarity model 702. The inputs can include a question 706 (or prompt), a new response 708, and one or more existing responses 710. The similarity model includes a machine learning model (e.g., a neural network) trained to determine a similarity between the new response and one or more of the existing responses 710. The question 706 can also be used as a factor to determine similarity in responses, as discussed below.

The similarity model is constructed and trained to determine similarity between the text of two responses so that responses to the same question with similar text receive a similar grade. The similarity model can use include Natural Language Processing (NLP) techniques to model language. The similarity model can be built by training the similarity model with a language model that includes a numerical representation of vocabulary trained on historical responses. For example, words can be represented in the model as numerical representation vectors.

The language model can then be used to create a numerical representation vector of the question (or prompt) and the two responses being compared for similarity. For example, similarity can be determined by the model based on the following:

Similarity=Response 1 Vector·Response 2 Vector−([Question vector·Response 1 vector]−[Question vector·Response 2 Vector])

In some implementations, the similarity model 702 can provide a function represented by the following:

F(S(R1,R2),|S(Q,R1)−S(Q,R2)|,overlap(R1,R2))

Where R1 and R2 are responses for which similarity is being assessed. Q is the question, S is a similarity function, overlap is an overlap function, and F is a function combining similarity and other features.

Outputs from the similarity model 702 can be provided to the grading model 704. The grading model 704 can include an ensemble decision tree machine learning model that can leverage existing grades for historical responses.

In operation, grading can include finding existing graded responses for the question. The similarity between the graded responses and new response is determined using the similarity model as discussed above resulting in a set of information that includes an existing response, a grade for that response, and the similarity measure value between that response and the new response being graded.

The known grades and similarities can be grouped in to similarity distributions per grade group, where responses having a same grade are grouped together and similarity values for the responses in each group are associated with the responses. The similarity distribution per grade group can be provided as input 712 to the grading model 704. The grading model can then produce a predicted or assigned grade 714.

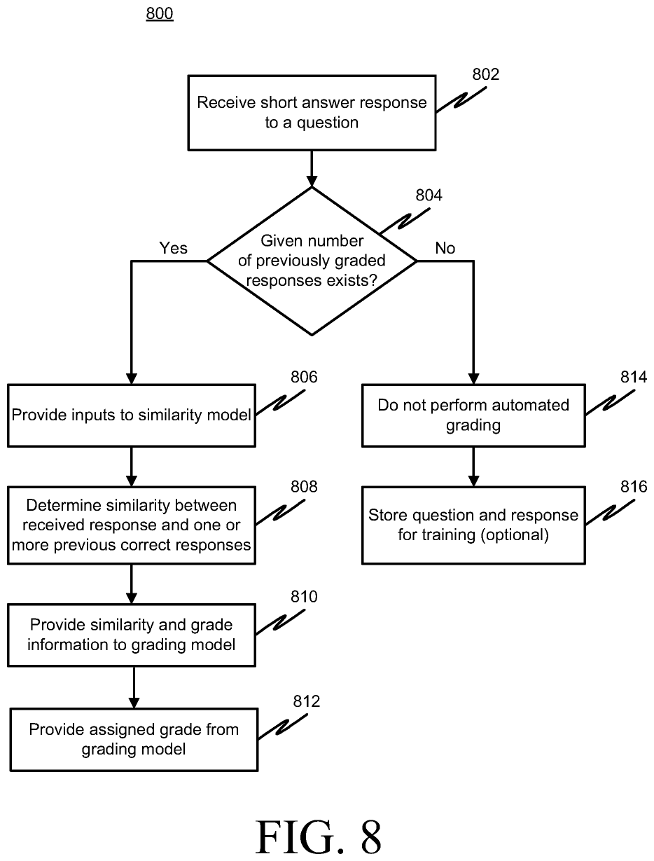

FIG. 8 is a flow diagram illustrating an example method 800 (e.g., a computer-implemented method) to predict grades for short answer responses, according to some implementations.

In some implementations, method 800 can be implemented, for example, on a server system 102 as shown in FIG. 1. In other implementations, some or all of the method 800 can be implemented on one or more student devices 120, 122, 124, or 126 as shown in FIG. 1, one or more server devices, and/or on both server device(s) and client device(s). In described examples, the implementing system includes one or more digital hardware processors or processing circuitry (“processors”), and one or more storage devices (e.g., a database 106 or other storage). In some implementations, different components of one or more servers and/or clients can perform different blocks or other parts of the method 800.

In some implementations, the method 800, or portions of the method, can be initiated automatically by a device. For example, the method (or portions thereof) can be periodically performed or performed based on the occurrence of one or more particular events or conditions. For example, such events or conditions can include a short answer response being received by, uploaded to, or otherwise being accessible by a device (e.g. a student device), a predetermined time period having expired since the last performance of method 800, and/or one or more other events or conditions occurring which can be specified in settings of a device implementing method 800. In some implementations, such conditions can be previously specified by a user in stored custom preferences of the user (accessible by a device or method with user consent). In some examples, a device (server or client) can perform the method 800 with access to one or more applications that receive short answer responses. In another example, a student device can receive electronic short answer responses and can perform the method 800. In addition, or alternatively, a client device can send one or more short answer responses to a server over a network, and the server can process the messages using method 800.

Processing begins at 802, where a short answer response is received. In addition to the response, a question and reading material associated with the response can also optionally be received. Processing continues to 804.

At 804, it is determined whether a threshold number of previously graded responses have been received for the question corresponding to the short answer response. For example, there may be a threshold number that is used to determine whether the similarity and grading models (e.g., 702 and 704) can be used to predict a grade for the short answer. If a threshold number of previously graded responses to the question exists, processing continues to 806, otherwise processing continues to 814.

At 806, previously graded responses to the question are identified. For example, these may be obtained from a database that stores correct answers to questions being graded and the correct answer corresponding to a particular question can be identified within the database (e.g., by question text, question number, etc.). Processing continues to 808.

At 808, a similarity between the short answer response and one or more of the identified existing responses (e.g., previously graded short answers) is determined. The similarity can represent the degree to which a short answer response matches historical responses (or the question or reading material). The similarity can be programmatically determined, e.g., using a similarity model such as 702, based on characters, words, word usage, word order, or word placement, etc. within the short answer response. Similarity can include a value having a range representing how similar the short answer response is to one or more identified correct short answers. Processing continues to 810.

At 810, the similarity determined at 808 and grades for existing responses are provided to a grading model (e.g., 704). Processing continues to 812.

At 812, a predicted or assigned grade is generated by the grading model and provided as output. The similarity and grade prediction of steps 808 and 812 can be performed by model trained using actual answers (e.g., models 702 and 704). Processing for the grade prediction ends at 810.

At 814, automatic grading is not performed due to lack of enough existing responses (e.g., not enough existing response to make similarity determination or grade prediction statistically accurate). Processing continues to 816.

At 816, the question and response are optionally stored for training the similarity or grading models. Also, once a grade has been manually determined for the response, the grade can optionally be associated with the question and response for training.

It will be appreciated that one or more of 802-816 can be repeated in whole or in part.

Upon determination ore prediction of the grade, the grade may be presented, e.g., via a user interface on a student device (e.g., any of devices 120-126), to a student that provided the short answer response. The grade can also be stored, e.g., in a database along with an identifier of the student. Further, the grade may be combined with, e.g., grades for other responses provided by the student during a particular test, e.g., to provide an overall score for the student for the particular test. Some implementations can provide a suggestion of the determined grade to the teacher, and allow the teacher to accept or modify the determined grade.

One or more methods described herein (e.g., methods 300, 400, or 800) can be implemented by computer program instructions or code, which can be executed on a computer. For example, the code can be implemented by one or more digital processors (e.g., microprocessors or other processing circuitry), and can be stored on a computer program product including a non-transitory computer readable medium (e.g., storage medium), e.g., a magnetic, optical, electromagnetic, or semiconductor storage medium, including semiconductor or solid state memory, magnetic tape, a removable computer diskette, a random access memory (RAM), a read-only memory (ROM), flash memory, a rigid magnetic disk, an optical disk, a solid-state memory drive, etc. The program instructions can also be contained in, and provided as, an electronic signal, for example in the form of software as a service (SaaS) delivered from a server (e.g., a distributed system and/or a cloud computing system). Alternatively, one or more methods can be implemented in hardware (logic gates, etc.), or in a combination of hardware and software. Example hardware can be programmable processors (e.g. Field-Programmable Gate Array (FPGA), Complex Programmable Logic Device), general purpose processors, graphics processors, Application Specific Integrated Circuits (ASICs), and the like. One or more methods can be performed as part of or component of an application running on the system, or as an application or software running in conjunction with other applications and operating system.

One or more methods described herein can be run in a standalone program that can be run on any type of computing device, a program run on a web browser, a mobile application (“app”) run on a mobile computing device (e.g., cell phone, smart phone, tablet computer, wearable device (wristwatch, armband, jewelry, headwear, goggles, glasses, etc.), laptop computer, etc.). In one example, a client/server architecture can be used, e.g., a mobile computing device (as a client device) sends user input data to a server device and receives from the server the final output data for output (e.g., for display). In another example, all computations can be performed within the mobile app (and/or other apps) on the mobile computing device. In another example, computations can be split between the mobile computing device and one or more server devices.

Short answer grade prediction can be performed using machine-learning techniques. For example, grading of short answer responses and/or test questions or materials can be learned using LSTM models, image/video content could be parsed using machine-learning models trained for object recognition; interactive objects could be recognized using models specially trained for those types of objects, etc. For example, test grading applications may implement machine learning, e.g., a deep learning model, which can enable automatic test grading. Machine-learning models may be trained using synthetic data, e.g., data that is automatically generated by a computer, with no use of user information. In some implementations, machine-learning models may be trained, e.g., based on sample data, for which permissions to utilize user data for training have been obtained expressly from users. For example, sample data may include short answer responses. Based on the sample data, the machine-learning model can predict grades.

In some implementations, a machine-learning application can include instructions that enable one or more processors to perform functions described herein, e.g., some or all of the method of FIGS. 3, 4 and/or 8.

In various implementations, a machine-learning application performing the functions described herein may utilize Bayesian classifiers, support vector machines, neural networks, or other learning techniques. In some implementations, a machine-learning application may include a trained model, an inference engine, and data. In some implementations, data may include training data, e.g., data used to generate trained model. For example, training data may include any type of data such as test questions, answers, true grades, etc. Training data may be obtained from any source, e.g., a data repository specifically marked for training, data for which permission is provided for use as training data for machine-learning, etc. In implementations where one or more users permit use of their respective user data to train a machine-learning model, e.g., trained model, training data may include such user data. In implementations where users permit use of their respective user data, data may include permitted data such as test questions/prompts, short answer responses, true grades (e.g., from an instructor) for the responses, and documents (e.g., lesson materials, etc.).

In some implementations, training data may include synthetic data generated for the purpose of training, such as data that is not based on user input or activity in the context that is being trained, e.g., data generated from previous tests and/or short answers. For example, in these implementations, the trained model may be generated, e.g., on a different device, and be provided as part of machine-learning application. In various implementations, the trained model may be provided as a data file that includes a model structure or form, and associated weights. An inference engine may read the data file for trained model and implement a neural network with node connectivity, layers, and weights based on the model structure or form specified in trained model.

A machine-learning application can also include a trained model. In some implementations, the trained model may include one or more model forms or structures. For example, model forms or structures can include any type of neural-network, such as a linear network, a deep neural network that implements a plurality of layers (e.g., “hidden layers” between an input layer and an output layer, with each layer being a linear network), etc. The model form or structure may specify connectivity between various nodes and organization of nodes into layers. For example, nodes of a first layer (e.g., input layer) may receive data as input data or application data. Such data can include, for example, one or more words of the short answer response per node, e.g., when the trained model is used for grading short answer responses. For example, the input layer takes questions and answers, which are fed into the second layer and undergo a transformation in that layer, that are then fed into a subsequent layer, etc. Subsequent intermediate layers, e.g., a pooling layer, may receive as input output of nodes of a previous layer per the connectivity specified in the model form or structure. These layers may also be referred to as hidden layers. A final layer (e.g., output layer), e.g., similarity computation or grade prediction layer, produces an output of the machine-learning application, e.g., predicted grade. For example, the output may be a predicted grade for a short answer. In some implementations, model form or structure also specifies a number and/or type of nodes in each layer.

In different implementations, the trained model can include a plurality of nodes, arranged into layers per the model structure or form. In some implementations, the nodes may be computational nodes with no memory, e.g., configured to process one unit of input to produce one unit of output. Computation performed by a node may include, for example, multiplying each of a plurality of node inputs by a weight, obtaining a weighted sum, and adjusting the weighted sum with a bias or intercept value to produce the node output. In some implementations, the computation may include applying a step/activation function to the adjusted weighted sum. In some implementations, the step/activation function may be a non-linear function. In various implementations, computation may include operations such as matrix multiplication. In some implementations, computations by the plurality of nodes may be performed in parallel, e.g., using multiple processors cores of a multicore processor, using individual processing units of a GPU, or special-purpose neural circuitry. In some implementations, nodes may include memory, e.g., may be able to store and use one or more earlier inputs in processing a subsequent input. For example, nodes with memory may include long short-term memory (LSTM) nodes. LSTM nodes may use the memory to maintain “state” that permits the node to act like a finite state machine (FSM). Models with such nodes may be useful in processing sequential data, e.g., words in a sentence or a paragraph, frames in a video, speech or other audio, etc.

In some implementations, the trained model may include embeddings or weights for individual nodes. For example, a model may be initiated as a plurality of nodes organized into layers as specified by the model form or structure. At initialization, a respective weight may be applied to a connection between each pair of nodes that are connected per the model form, e.g., nodes in successive layers of the neural network. For example, the respective weights may be randomly assigned, or initialized to default values. The model may then be trained, e.g., using data, to produce a result.

For example, training may include applying supervised learning techniques. In supervised learning, the training data can include a plurality of test questions, short answer responses, response grades, lesson materials, etc. Based on a comparison of the output of the model with the expected output, values of the weights are automatically adjusted, e.g., in a manner that increases a probability that the model produces the expected output when provided similar input.

In some implementations, training may include applying unsupervised learning techniques. In unsupervised learning, only input data may be provided and the model may be trained to differentiate data, e.g., to cluster input data into a plurality of groups, where each group includes input data that are similar in some manner.

The machine-learning application can also include an inference engine. The inference engine is configured to apply the trained model to data, such as application data, to provide an inference. In some implementations, the inference engine may include software code to be executed by a processor. In some implementations, the inference engine may specify circuit configuration (e.g., for a programmable processor, for a field programmable gate array (FPGA), etc.) enabling a processor to apply the trained model. In some implementations, the inference engine may include software instructions, hardware instructions, or a combination. In some implementations, the inference engine may offer an application programming interface (API) that can be used by an operating system and/or other applications to invoke the inference engine, e.g., to apply the trained model to application data to generate an inference.

A machine-learning application may provide several technical advantages. For example, a model trained for determining similarity of short answer responses to prior graded answers may produce similarity values that are substantially smaller in size (e.g., a few bytes) than input short answers (e.g., a few kilobytes). In some implementations, such representations may be helpful to reduce processing cost (e.g., computational cost, memory usage, etc.) to generate an output (e.g., a grade). In some implementations, such representations may be provided as input to a different machine-learning application that produces output from the output of the inference engine.

In some implementations, the machine-learning application may be implemented in an offline manner. In these implementations, the trained model may be generated in a first stage, and provided as part of the machine-learning application. In some implementations, the machine-learning application may be implemented in an online manner. For example, in such implementations, an application that invokes the machine-learning application (e.g., the operating system, and/or one or more other applications) may utilize an inference produced by the machine-learning application, e.g., provide the inference to a user, and may generate system logs (e.g., if permitted by the user, an action taken by the user based on the inference; or if utilized as input for further processing, a result of the further processing). System logs may be produced periodically, e.g., hourly, monthly, quarterly, etc. and may be used, with user permission, to update the trained model, e.g., to update embeddings for the trained model.

Any of software in memory can alternatively be stored on any other suitable storage location or computer-readable medium. In addition, the memory (and/or other connected storage device(s)) can store one or more messages, one or more taxonomies, electronic encyclopedia, dictionaries, thesauruses, knowledge bases, message data, grammars, user preferences, and/or other instructions and data used in the features described herein. The memory and any other type of storage (magnetic disk, optical disk, magnetic tape, or other tangible media) can be considered “storage” or “storage devices.”

An I/O interface can provide functions to enable interfacing the server device with other systems and devices. Interfaced devices can be included as part of a device or can be separate and communicate with the device. For example, network communication devices, storage devices (e.g., memory and/or database 106), and input/output devices can communicate via the I/O interface. In some implementations, the I/O interface can connect to interface devices such as input devices (keyboard, pointing device, touchscreen, microphone, camera, scanner, sensors, etc.) and/or output devices (display devices, speaker devices, printers, motors, etc.).

Some examples of interfaced devices that can connect to the I/O interface can include one or more display devices that can be used to display content, e.g., images, video, and/or a user interface of an output application as described herein. A display device can be connected to a device via local connections (e.g., display bus) and/or via networked connections and can be any suitable display device. The display device can include any suitable display device such as an LCD, LED, or plasma display screen, CRT, television, monitor, touchscreen, 3-D display screen, or other visual display device. For example, the display device can be a flat display screen provided on a mobile device, multiple display screens provided in a goggles or headset device, or a monitor screen for a computer device.

The I/O interface can interface to other input and output devices. Some examples include one or more cameras which can capture images. Some implementations can provide a microphone for capturing sound (e.g., as a part of captured images, voice commands, etc.), audio speaker devices for outputting sound, or other input and output devices.

Although the description has been described with respect to particular implementations thereof, these particular implementations are merely illustrative, and not restrictive. Concepts illustrated in the examples may be applied to other examples and implementations.

Note that the functional blocks, operations, features, methods, devices, and systems described in the present disclosure may be integrated or divided into different combinations of systems, devices, and functional blocks as would be known to those skilled in the art. Any suitable programming language and programming techniques may be used to implement the routines of particular implementations. Different programming techniques may be employed, e.g., procedural or object-oriented. The routines may execute on a single processing device or multiple processors. Although the steps, operations, or computations may be presented in a specific order, the order may be changed in different particular implementations. In some implementations, multiple steps or operations shown as sequential in this specification may be performed at the same time.

What is claimed is:

1. A computer-implemented method comprising:
receiving a short answer response to a test prompt;
determining a number of previously graded responses to the test prompt;
when the number of previously graded responses to the test prompt meets a threshold:
providing the short answer response, one or more previously graded responses, and the test prompt to a similarity model;
determining, using the similarity model, a similarity between the short answer response and the one or more previously graded responses;
providing the similarity between the short answer response and the one or more previously graded responses and a previously determined grade for the one or more previously graded responses to a grading model; and
generating, using the grading model, a grade prediction for the short answer response.

2. The method of claim 1, wherein determining the similarity between the short answer response and the previously graded responses includes programmatically determining the similarity based on one or more of characters, words, word usage, word order, or word placement within the short answer response.

3. The method of claim 1, wherein determining the similarity between the short answer response and the previously graded responses includes determining a value having a range representing a degree of similarity between the short answer response and the previously graded responses.

4. The method of claim 1, further comprising displaying a user interface that presents the grade prediction.

5. The method of claim 4, further comprising storing the grade prediction in a database.

6. The method of claim 4, further comprising combining the grade prediction with grades for other responses provided during a particular test to generate an overall score for the particular test.

7. The method of claim 1, further comprising:
providing a suggestion of the grade prediction to a teacher; and
providing a user interface for the teacher to accept or modify the grade prediction.

8. The method of claim 1, further comprising using a language model to model language of the test prompt and the short answer response.

9. The method of claim 8, further comprising:
training the similarity model, wherein the training of the similarity model includes:
generating one or more question and answer tuples as training samples, wherein the question and answer tuples each include two or more answers;
providing the one or more question and answer tuples to the similarity model;
generating a similarity score representing similarity between the two or more answers;
predicting a grade based on the similarity score using the grading model; and
adjusting one or more parameters of the similarity model based on the grade predicted by the grading model.

10. The method of claim 9, wherein training the similarity model further comprises comparing the grade predicted by the similarity model with a known grade for a corresponding training sample, wherein the similarity model includes a neural network and wherein adjusting one or more parameters of the similarity model includes adjusting one or more weights in one or more layers of the neural network using as feedback a difference between the grade predicted by the grading model and the known grade for the corresponding training sample, and
wherein training the similarity model is completed when one or more grades predicted by the grading model are within a threshold of one or more corresponding known grades.

11. The method of claim 1, further comprising providing as input to the similarity model a first similarity function result based on the short answer response and one of the previously graded responses, a second similarity function result based on the short answer response, one of the previously graded responses and the test prompt, and an overlap function results based on the short answer response and one of the previously graded responses.

12. The method of claim 1, further comprising providing as input to the grading model a distribution of the similarity between the short answer response, the one or more previously graded responses, and grades for the one or more previously graded responses.

13. A non-transitory computer readable medium having stored thereon instructions that, when executed by a processor, cause the processor to perform operations comprising:
receiving a short answer response to a test prompt;
determining a number of previously graded responses to the test prompt;
when the number of previously graded responses to the test prompt meets a threshold:
providing the short answer response, one or more previously graded responses, and the test prompt to a similarity model;
determining, using the similarity model, a similarity between the short answer response and the one or more previously graded responses;
providing the similarity between the short answer response and the one or more previously graded responses and a previously determined grade for the one or more previously graded responses to a grading model; and
generating, using the grading model, a grade prediction for the short answer response.

14. The non-transitory computer readable medium of claim 13, wherein determining the similarity between the short answer response and one or more previously graded responses includes programmatically determining a similarity based on characters, words, word usage, word order, or word placement within the short answer response.

15. The non-transitory computer readable medium of claim 13, wherein determining the similarity between the short answer response and one or more previously graded responses includes determining a value having a range representing a degree of similarity between the short answer response and the one or more previously graded responses.

16. A system comprising:
one or more processors; and
a memory coupled to the one or more processors and having instructions stored thereon that, when executed, cause the one or more processors to perform operations including:
receiving a short answer response to a test prompt;
determining a number of previously graded responses to the test prompt;
when the number of previously graded responses to the test prompt meets a threshold:
providing the short answer response, one or more previously graded responses, and the test prompt to a similarity model;
determining, using the similarity model, a similarity between the short answer response and the one or more previously graded responses;
providing the similarity between the short answer response and the one or more previously graded responses and a previously determined grade for the one or more previously graded responses to a grading model; and
generating, using the grading model, a grade prediction for the short answer response.

17. The system of claim 16, wherein the operations further comprise combining the grade prediction with grades for other responses provided by a student during a particular test to generate an overall score for the student for the particular test.

18. The system of claim 17, wherein the operations further comprise:
providing a suggestion of the grade prediction to a teacher; and
providing a user interface for the teacher to accept or modify the grade prediction.

19. The system of claim 17, wherein the operations further comprise providing as input to the similarity model a first similarity function result based on the short answer response and one of the previously graded responses, a second similarity function result based on the short answer response, one of the previously graded responses and the test prompt, and an overlap function results based on the short answer response and one of the previously graded responses.

20. The system of claim 17, wherein the operations further comprise providing as input to the grading model a distribution of the similarity between the short answer response, the one or more previously graded responses, and grades for the one or more previously graded responses.
